(19) United States
(12) Patent Application Publication
(10) Pub. No.: US 2011/0067571 A1
(43) Pub. Date: Mar. 24, 2011

(54) AIR PURIFICATION APPARATUS

(76) Inventors: Yukiyasu Asano, Kobe-shi (JP); Fumio Mihara, Kyoto-shi (JP); Yutaka Uratani, Hikone-shi (JP)

(21) Appl. No.: 12/993,528

(22) PCT Filed: May 7, 2009
(86) PCT No.: PCT/JP2009/058634

§ 371 Date: Nov. 19, 2010

(30) Foreign Application Priority Data
May 27, 2008 (JP) 2008-138650

(51) Int. Cl. B03C 3/38; B03C 3/36

(52) U.S. Cl. 96/27

(57) ABSTRACT

The air purification apparatus includes a duct (10), a filter (20) for air purification, an electrostatically atomizing device (30), a fan (40), and a switching device (50). The duct (10) has an inlet (11) and an outlet (12). The filter (20) is placed inside of the duct (10). The electrostatically atomizing device (30) is configured to generate a mist of charged minute water particles by means of electrostatically atomizing phenomenon and discharge the same into the duct (10). The fan (40) is configured to send air from the inlet (11) to the outlet (12). The switching device (50) is configured to switch one of a first mode and a second mode. The air purification apparatus is configured to send a mist of charged minute water particles from the electrostatically atomizing device (30) to the outlet (12) not through the filter (20) in said first mode. The air purification apparatus is configured to send a mist of charged minute water particles from the electrostatically atomizing device (30) to the filter (20) in the second mode.

### TECHNICAL FIELD

The present invention is directed to air purification apparatuses, and more particularly to an air purification apparatus including an electrostatically atomizing device.

### BACKGROUND ART

As disclosed in Japanese patent laid-open publication No. 2004-85185 (hereinafter referred to as “document 1”), and Japanese patent laid-open publication No. 2005-180865 (hereinafter referred to as “document 2”), there has been proposed an air purification apparatus provided with an electrostatically atomizing device.

In the air purification apparatuses respectively disclosed in the documents 1 and 2, a filter is placed inside of an air duct.

Notably, concerning the air purification apparatus disclosed in the document 1, the electrostatically atomizing device is placed downstream of the filter. Therefore, a mist of charged minute water particles generated by the electrostatically atomizing device is discharged into an external space not through the filter. The air purification apparatus disclosed in the document 1 discharges a mist of charged minute water particles into the external space in order to purify air in the external space by use of a mist of charged minute water particles.

In the air purification apparatus disclosed in the document 2, the electrostatically atomizing device is placed upstream of the filter. Therefore, a mist of charged minute water particles generated by the electrostatically atomizing device comes into contact with the filter. The air purification apparatus disclosed in the document 2 makes a mist of charged minute water particles into contact with the filter in order to regenerate the filter by use of a mist of charged minute water particles.

As apparent from the above configurations, the air purification apparatus of the document 1 does not utilize the electrostatically atomizing device to regenerate the filter, and the air purification apparatus of the document 2 does not utilize the electrostatically atomizing device to purify air in the external space.

In order to make both air purification and filter regeneration, the electrostatically atomizing devices can be placed both downstream and upstream of the filter.

However, with this situation, at least two electrostatically atomizing devices are required. As a result, the air purification apparatus is likely to be upsized and its cost is likely to become high.

### DISCLOSURE OF INVENTION

In view of the above insufficiency, the present invention has been aimed to propose an air purification apparatus capable of making both air purification and filter regeneration by use of a single electrostatically atomizing device.

The air purification apparatus in accordance with the present invention includes a duct, a filter designed to purify air, an electrostatically atomizing device, a fan, and a switching means. The duct has an inlet and an outlet. The filter is placed inside of the duct. The electrostatically atomizing device is configured to generate a mist of charged minute water particles by means of electrostatically atomizing phenomenon and discharge the same into the duct. The fan is configured to send air from the inlet to the outlet. The switching means is configured to switch one of a first mode and a second mode. The air purification apparatus is configured to send a mist of charged minute water particles from the electrostatically atomizing device to the outlet without passing through the filter in the first mode. The air purification apparatus is configured to send a mist of charged minute water particles from the electrostatically atomizing device to the filter in the second mode.

According to the air purification apparatus in accordance with the present invention, it is possible to purify air in the first mode, and to regenerate the filter in the second mode. Further, the first mode and the second mode can be switched by use of the switching means. Consequently, the air purification apparatus in accordance with the present invention is capable of making both air purification and filter regeneration by use of the single electrostatically atomizing device. Therefore, it is possible to downsize the air purification apparatus, and to reduce a production cost. In addition, in the first mode, a mist of charged minute water particles is discharged out from the duct not through the filter. Thus, it is possible to prevent occurrence of a decrease of an amount of a mist of charged minute water particles discharged out from the duct caused by the filter. As a result, it is possible to provide an enough amount of a mist of charged minute water particles discharged out from the duct. Moreover, since the filter can be regenerated in the second mode, it is possible to reduce replacement frequency of filter. Thus, maintenance need not be made for a long time.

In a preferred embodiment, the electrostatically atomizing device is configured to discharge a mist of charged minute water particles into a space formed inside of the duct between the filter and the outlet. The switching means includes a changing means and a controlling means configured to control the changing means. The changing means is configured to change a discharge direction where the electrostatically atomizing device discharges a mist of charged minute water particles. The controlling means is configured to direct the discharge direction toward the outlet when the first mode is selected. The controlling means is configured to direct the discharge direction toward the filter when the second mode is selected.

With the preferred embodiment, it is possible to easily and successfully select one of the first mode and the second mode.

In a preferred embodiment, the electrostatically atomizing device is configured to discharge a mist of charged minute water particles into a space formed inside of the duct between the filter and the outlet. The fan is configured to operate in an air supply mode of sending air from the inlet to the outlet, and an exhaust mode of sending air from the outlet to the inlet. The switching means includes a controlling means configured to control the fan. The controlling means is configured to control the fan to operate in the air supply mode when the first mode is selected, and to control the fan to operate in the exhaust mode when the second mode is selected.

With the preferred embodiment, it is possible to easily and successfully select one of the first mode and the second mode.

In a preferred embodiment, the electrostatically atomizing device is placed inside of the duct. The duct includes, between the outlet and the electrostatically atomizing device, a first air passage devoid of the filter and a second air passage provided with the filter. The switching means includes a shutter configured to block the first air passage and the second air passage selectively. The switching means includes a controlling means configured to control the shutter. The controlling means is configured to control the shutter to block the second air passage when the first mode is selected. The controlling means is configured to control the shutter to block the first air passage when the second mode is selected.

With the preferred embodiment, it is possible to easily and successfully select one of the first mode and the second mode.

In a preferred embodiment, the electrostatically atomizing device is configured such that an amount of a mist of charged minute water particles generated per unit time is greater in the second mode than in the first mode.

With the preferred embodiment, it is possible to shorten time necessitated for regenerating the filter.

### BRIEF DESCRIPTION OF DRAWINGS

FIG. 1A is a schematic explanatory view illustrating an air purification apparatus of a first embodiment operating in a first mode,

FIG. 1B is a schematic explanatory view illustrating the air purification apparatus of the first embodiment operating in a second mode,

FIG. 2 is a schematic explanatory view illustrating an electrostatically atomizing device of the above air purification apparatus,

FIG. 3 is an explanatory view illustrating a modification of the above air purification apparatus,

FIG. 4A is a schematic explanatory view illustrating an air purification apparatus of a second embodiment operating in a first mode,

FIG. 4B is a schematic explanatory view illustrating the air purification apparatus of the second embodiment operating in a second mode,

FIG. 5A is a schematic explanatory view illustrating an air purification apparatus of a third embodiment operating in a first mode,

FIG. 5B is a schematic explanatory view illustrating the air purification apparatus of the third embodiment operating in a second mode, and

FIG. 6 is an explanatory view illustrating a modification of the above air purification apparatus.

### BEST MODE FOR CARRYING OUT THE INVENTION

### First Embodiment

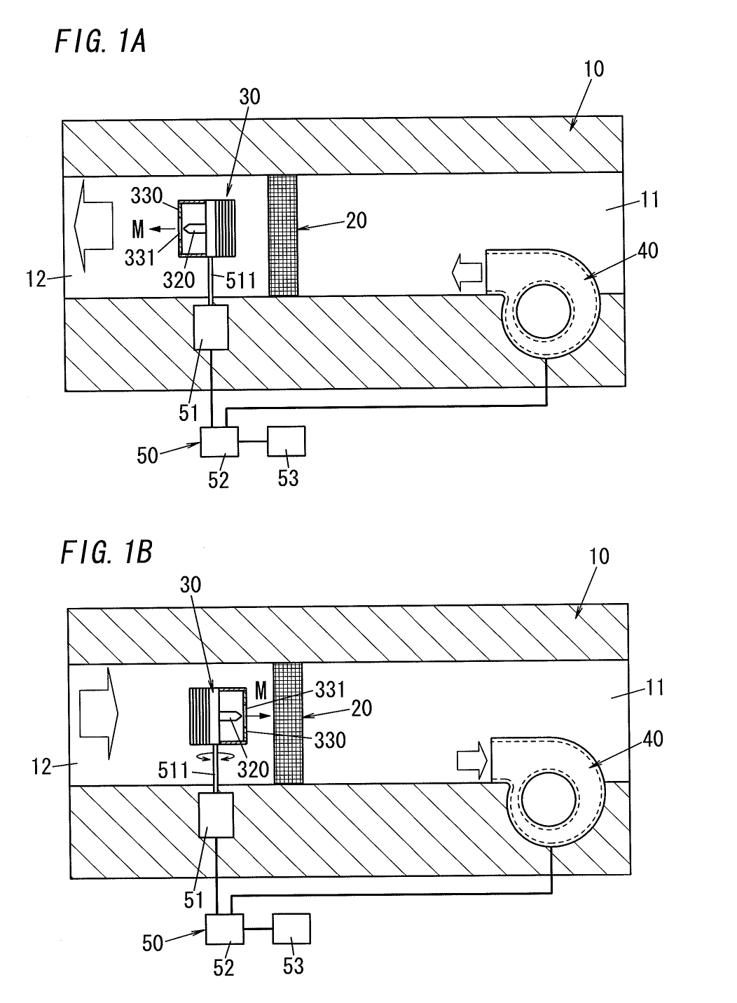

As shown in FIGS. 1A and 1B, an air purification apparatus of the present embodiment includes a duct 10, a filter 20 for air purification, an electrostatically atomizing device 30, a fan 40, and a switching device (switching means) 50.

The duct 10 is mounted on a housing which is a casing of the air purification apparatus. The duct 10 is shaped into a cylindrical shape, for example. A first axial opening (right opening, in FIGS. 1A and 1B) of the duct 10 is defined as an inlet 11. The inlet 11 is used for introducing air into the duct 10 from the outside. A second axial opening (left opening, in FIGS. 1A and 1B) of the duct 10 is defined as an outlet 12. The outlet 12 is used for discharging air to the outside from the inside of the duct 10.

The filter 20 is placed inside of the duct 10. For example, the filter 20 is a deodorization filter configured to remove offensive odor substances from air utilizing an activated carbon.

The fan 40 is placed close to the inlet 11 within the duct 10. The fan 40 is configured to operate in two working modes, one being an air supply mode and the other being an exhaust mode. The fan 40 sends air from the inlet 11 to the outlet 12 in the air supply mode. The fan 40 sends air from the outlet 12 to the inlet 11 in the exhaust mode. In the present embodiment, based on a situation where the fan 40 operates in the air supply mode, a side of the inlet 11 of the duct 10 is defined as an upstream side, and a side of the outlet 12 of the duct 10 is defined as a downstream side.

The electrostatically atomizing device 30 is configured to generate a mist of charged minute water particles by means of electrostatically atomizing phenomenon and discharge the same into the duct 10. In the present embodiment, the electrostatically atomizing device 30 is placed between the filter 20 and the outlet 12 in the duct 10. Consequently, the electrostatically atomizing device 30 discharges a mist of charged minute water particles into a space formed inside of the duct 10 between the filter 20 and the outlet 12.

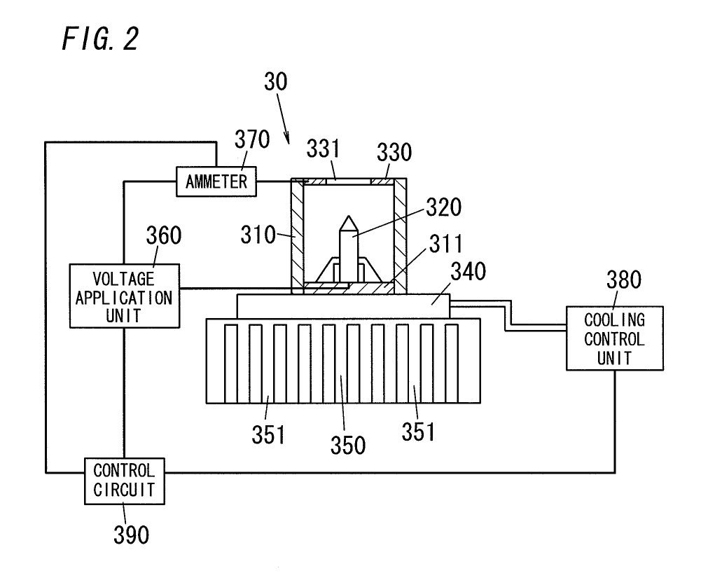

As shown in FIG. 2, the electrostatically atomizing device 30 includes a housing 310.

The housing 310 is made of a dielectric material and is shaped into a cylindrical shape. The first axial opening (lower opening shown in FIG. 2) of the housing 310 is covered with a cooling plate 311. The housing 310 houses a discharge electrode 320.

The discharge electrode 320 is shaped into a bar shape having a sharp tip. The discharge electrode 320 has its base end thermally coupled to the cooling plate 311.

There is an opposed electrode 330 which is placed inside of a second opening (upper opening shown in FIG. 2) of the housing 310.

The opposed electrode 330 is shaped into a plate shape having enough dimensions to cover the second opening of the housing 310. The opposed electrode 330 is provided with a spray hole 331 in its center.

The tip of the discharge electrode 320 is visible from the outside of the housing 310 via the spray hole 331.

A peltier unit 340 having a peltier element (not shown) is attached to the first opening side of the housing 310.

The peltier unit 340 is used for cooling the discharge electrode 320. Therefore, the peltier unit 340 has its cooling side thermally coupled to the discharge electrode 320 through the cooling plate 311. The pettier unit 340 has its heat dissipation side attached to a heat dissipation unit 350 having plural fins 351.

The electrostatically atomizing device 30 includes, as circuit components, a voltage application unit 360, an ammeter 370, a cooling control unit 380, and a control circuit 390.

The voltage application unit 360 is configured to apply a voltage (DC voltage) between the discharge electrode 320 and the opposed electrode 330. For example, the voltage application unit 360 is an AC/DC converter which is configured to apply a voltage between the discharge electrode 320 and the opposed electrode 330 by use of power received from a commercial AC source.

The ammeter 370 is configured to measure a current flowing between the discharge electrode 320 and the opposed electrode 330.

The cooling control unit 380 is configured to energize the peltier element of the peltier unit 340. The cooling control unit 380 has a function of adjusting a voltage applied to the peltier element.

The control circuit 390 is constructed by use of a microcomputer, for example.

The control circuit 390 is configured to control the cooling control unit 380 to cool the discharge electrode 320 below a dew point of circumambient air. When the discharge electrode 320 is cooled below the aforementioned dew point, moisture in the circumambient air is condensed on the surface of the discharge electrode 320. Consequently, dew is produced on the surface of the discharge electrode 320. That is, the electrostatically atomizing device 30 of the present embodiment is configured to supply water (dew condensation water) to the discharge electrode 320 utilizing dew condensation (surface condensation).

Especially, the control circuit 390 of the present embodiment adjusts the temperature of the discharge electrode 320 to either a first configuration temperature or a second configuration temperature. Both the first configuration temperature and the second configuration temperature are selected to be not greater than the above dew point. The second configuration temperature is lower than the first configuration temperature. Therefore, the discharge electrode 320 develops the dew on its surface in a greater amount when it is at second preset temperature than at the first preset temperature.

The control unit 390 is configured to control the voltage application unit 360 with reference to a detection result of the ammeter 370 in order to apply a predetermined voltage (e.g., 5000V) between the discharge electrode 320 and the opposed electrode 330. Therefore, water held by the discharge electrode is atomized, and then a mist of charged minute water particles is generated. A mist of charged minute water particles is discharged out of the housing 310 via the spray hole 331 of the opposed electrode 330. A principle of the electrostatically atomizing is well known, and no explanation thereof is deemed necessary.

The air purification apparatus of the present embodiment is configured to operate in two operation modes, one being a first mode and the other being a second mode. In the first mode, the air purification apparatus sends a mist of charged minute water particles from the electrostatically atomizing device to the outlet 12 not through the filter 20 (see FIG. 1A). In the second mode, the air purification apparatus sends a mist of charged minute water particles from the electrostatically atomizing device to the filter 20 (see FIG. 1B). Besides, arrows respectively shown in FIG. 1A and FIG. 1B indicate a direction of air.

The switching device 50 is configured to switch one of the first mode and the second mode.

The switching device 50 includes an electric motor 51, a control unit 52, and a manipulation unit 53.

The electric motor 51 is a stepping motor, for example. The electric motor 51 has a stator (not shown) fixed to the duct 10. The electric motor 51 includes a rotation axis 511 configured to rotate with a rotor (not shown). The rotation axis 511 has its tip fixed to the electrostatically atomizing device 30. A discharge direction M in which the electrostatically atomizing device 30 discharges a mist of charged minute water particles is perpendicular to an axial direction of the rotation axis 511. Therefore, with a rotation of the rotation axis 511, the discharge direction M is changed. In the present embodiment, the electric motor 51 is defined as a changing means configured to change the discharge direction M.

The manipulation unit 53 is used for making the switching one of the first mode and the second mode by manual operation, for example. The manipulation unit 53 is constructed by use of a switch or button, for example.

The control unit 52 is configured to control the electric motor 51, the fan 40, and the control circuit 390 in accordance with the operation mode of the air purification apparatus. The control unit 52 is configured to switch one of the first mode and the second mode corresponding to manual operation of the manipulation unit 53. The control unit 52 is constructed by use of a microcomputer, for example.

When the first mode is selected, the control unit 52 rotates the rotation axis 511 of the electric motor 51 to direct the discharge direction M toward the outlet 12 (downstream side). In addition, the control unit 52 controls the fan 40 to operate in the air supply mode. Further, the control unit 52 controls the control circuit 390 to adjust the temperature of the discharge electrode 320 to the first configuration temperature.

Therefore, in the first mode, a mist of charged minute water particles is discharged from the electrostatically atomizing device 30 towards the outlet 12. Further, since the fan 40 sends air towards the downstream side, a mist of charged minute water particles is moved towards the outlet 12 as being carried on an air flow.

As seen from the above, the first mode is defined as a purification mode (external space purification mode) of discharging out a mist of charged minute water particles via the outlet 12 without passing through the filter 20. When discharged into the external space, the mist of charged minute water particles remains floating in the air for a long time, and spread through every corner of the space. Thus, radical species contained in a mist of charged minute water particles removes offensive odor substances from the external space.

When the second mode is selected, the control unit 52 rotates the rotation axis 511 of the electric motor 51 to direct the discharge direction M toward the filter 20 (upstream side). In addition, the control unit 52 controls the fan 40 to operate in the exhaust mode. Further, the control unit 52 controls the control circuit 390 to adjust the temperature of the discharge electrode 320 to the second configuration temperature. Besides, in the second mode, the fan 40 may be deactivated instead of operating in the exhaust mode (it is sufficient that the fan 40 does not operate in the air supply mode).

Therefore, in the second mode, a mist of charged minute water particles is discharged from the electrostatically atomizing device 30 towards the filter 20. Further, since the fan 40 sends air towards the upstream side, a mist of charged minute water particles is moved towards the filter 20 as being carried on an air flow.

As seen from the above, the second mode is defined as a regeneration mode (filter regeneration mode) of spraying the mist of charged minute water particles into the filter 20 for regeneration thereof. When contacting with the filter 20, the charged minute water particles have its radical species functioning to remove offensive odor substances from the filter 20 for regeneration thereof.

As described in the above, the air purification apparatus of the present embodiment includes the duct 10, the filter 20, the electrostatically atomizing device 30, the fan 40, and the switching device 50. The duct 10 has the inlet 11 and the outlet 12. The filter 20 is placed the inside of the duct 10. The electrostatically atomizing device 30 is configured to generate a mist of charged minute water particles by means of electrostatically atomizing phenomenon and discharge the same into the duct 10. The fan 40 is configured to send air from the inlet 11 to the outlet 12. The switching means 50 is configured to switch one of the first mode and the second mode. The air purification apparatus sends a mist of charged minute water particles from the electrostatically atomizing device 30 to the outlet 12 not through the filter 20 in the first mode. The air purification apparatus sends a mist of charged minute water particles from the electrostatically atomizing device 30 to the filter 20 in the second mode.

Thus, the air purification apparatus of the present embodiment can purify air in the first mode, and can regenerate the filter 20 in the second mode. Further, the switching device 50 can switch one of the first mode and the second mode.

Consequently, the air purification apparatus of the present embodiment is capable of making both purification of air and regeneration of the filter 20 by use of the single electrostatically atomizing device 30. Therefore, it is possible to downsize the air purification apparatus, and to reduce a production cost. In addition, in the first mode, a mist of charged minute water particles is discharged out from the duct 10 not through the filter 20. Thus, it is possible to prevent occurrence of a decrease of an amount of a mist of charged minute water particles discharged out from the duct 10 caused by the filter 20. As a result, it is possible to provide an enough amount of a mist of charged minute water particles discharged out from the duct 10. Moreover, since the filter 20 can be regenerated in the second mode, it is possible to reduce replacement frequency of filter 20. Thus, maintenance need not be made for a long time.

Especially, the electrostatically atomizing device 30 is configured to discharge a mist of charged minute water particles into the space formed inside of the duct 10 between the filter 20 and the outlet 12.

The switching device 50 includes the electric motor 51 as the changing means, and the control unit 52 configured to control the electric motor 51. The electric motor 51 is configured to change the discharge direction M. The control unit 52 is configured to direct the discharge direction M toward the outlet 12 when the first mode is selected, and to direct the discharge direction M toward the filter 20 when the second mode is selected.

Accordingly, it is possible to easily and successfully select one of the first mode and the second mode.

Additionally, in the second mode, the discharge electrode 320 has the second configuration temperature. Therefore, dew generated on the surface of the discharge electrode 320 is greater in the second mode than in the first mode. As a result, a generation amount of a mist of charged minute water particles is increased.

In other words, the electrostatically atomizing device 30 is configured such that an amount of a mist of charged minute water particles generated per unit time is greater in the second mode than in the first mode.

Therefore, in contrast to a situation where an amount of a mist of charged minute water particles generated per unit time is the same in the second mode as in the first mode, it is possible to shorten time necessitated for regeneration of the filter.

Beside, a large amount of ozone is generated while a large amount of a mist of charged minute water particles is generated. However, since both ozone and a mist of charged minute water particles come into contact with the filter 20, the filter 20 prevents both ozone and a mist of charged minute water particles from being discharged out. Therefore, it is possible to assure safety of the air purification apparatus.

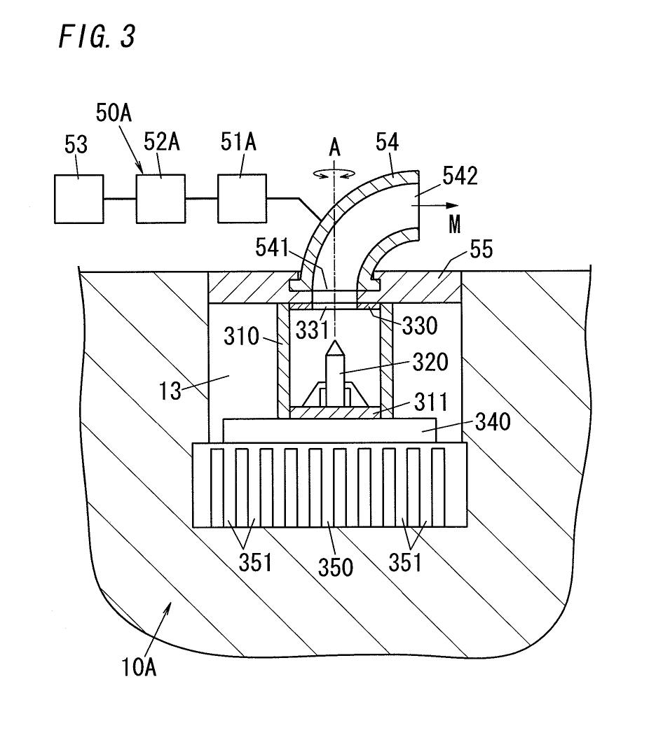

FIG. 3 shows a modification of the air purification apparatus of the present embodiment. Besides, the circuit components of the electrostatically atomizing device 30 are not shown in FIG. 3.

In the modification shown in FIG. 3, the duct 10A is provided in its inner surface with a storing recess 13 configured to receive the electrostatically atomizing device 30. The storing recess 13 is located between the outlet 12 and the filter 20.

The electrostatically atomizing device 30 is accommodated within the storing recess with its spray hole 331 directed towards an opening of the storing recess 13.

The switching device 50A shown in FIG. 3 includes the electric motor 51A, the control unit 52, the manipulation unit 53, a pipe 54, and a bearing plate 55.

The pipe 54 is shaped into a cylindrical shape. The pipe 54 is provided with a first opening 541 in its first axial end, and provided with a second opening 542 in its second axial end. The pipe 54 has an arc-shaped axis having a central angle of 90 degree. Therefore, the first opening 541 has its central axis perpendicular to a central axis of the second opening 542.

The bearing plate 55 is attached to the duct 10A to cover the storing recess 13. The bearing plate 55 bears the pipe 54 such that the first opening 541 and the spray hole 331 communicate with each other. Additionally, the bearing plate 55 is configured to hold the pipe 54 rotatively around a rotation axis A (see FIG. 3). The rotation axis A is aligned with the central axis of the first opening 541.

The electric motor 51A is configured to rotate the pipe 54 around the rotation axis A. The electric motor 51A is a stepping motor, for example. The electric motor 51A has a stator (not shown) fixed to the bearing plate 55. The electric motor 51A includes a rotor (not shown) which is mechanically coupled to the pipe 54 such that the pipe 54 rotates with a rotation of the rotor.

In the instance shown in FIG. 3, a mist of charged minute water particles is discharged into the duct 10 from the electrostatically atomizing device 30 through the pipe 54. A direction toward which the second opening 542 is directed is defined as the discharge direction M. The discharge direction M is perpendicular to the rotation axis A, because of that the discharge direction M is aligned with the central axis of the second opening 542.

Consequently, the discharge direction M is changed with a rotation of the pipe 54. In the instance shown in FIG. 3, the electric motor 51A, the pipe 54, and the bearing plate 55 constitute the changing means configured to change the discharge direction M.

In addition, as described in the above, the storage recess 13 is located between the outlet 12 and the filter 20. Therefore, the electrostatically atomizing device 30 discharges a mist of charged minute water particles into the space formed inside of the duct 10 between the filter 20 and the outlet 12.

The control unit 52A is configured to control the electric motor 51A, the fan 40, and the control circuit 390 in accordance with the operation mode of the air purification apparatus. Besides, the control unit 52A controls the fan 40 and the control circuit 390 in a similar manner as seen in the control unit 52, and no explanation thereof is deemed necessary.

When the first mode is selected, the control unit 52A rotates the pipe 54 to direct the discharge direction M toward the outlet 12. Thus, in the first mode, a mist of charged minute water particles is discharged toward the outlet 12 from the electrostatically atomizing device 30. Further, since the fan 40 sends air towards the downstream side, a mist of charged minute water particles is moved towards the outlet 12 as being carried on an air flow.

When the second mode is selected, the control unit 52A rotates the pipe 54 to direct the discharge direction M towards the filter 20. Thus, in the second mode, a mist of charged minute water particles is discharged from the electrostatic atomizing device 30 towards the filter 20. Further, since the fan 40 sends air towards the upstream side, a mist of charged minute water particles is moved towards the filter 20 as being carried on an air flow.

Accordingly, the modification of the air purification apparatus shown in FIG. 3 also can provide the same effect as the instance shown in FIG. 1.

Besides, the air purification apparatus of the present embodiment and the following second and third embodiments is defined as an apparatus having at least an air purification function, and therefore may be an air conditioner of cooling and/or heating air, a humidifier, a dehumidifier, a humidification and air purification apparatus, a vacuum cleaner, or a fan heater.

In addition, the filter 20 used in the present embodiment and the following second and third embodiments is not limited to a deodorization filter. The filter 20 may be a dust collection filter (e.g., HEPA filter) configured to collect particles floating in the air, or a sterilization filter designed to remove bacteria and viruses. Alternatively, the filter 20 may have both a function of deodorization and a function of removing dusts, bacteria, and viruses. A filter having a desired function can be adopted as the filter 20. Moreover, a mist of charged minute water particles can regenerate a sterilization filter, because of that a mist of charged minute water particles inactivates bacteria and viruses.

### Second Embodiment

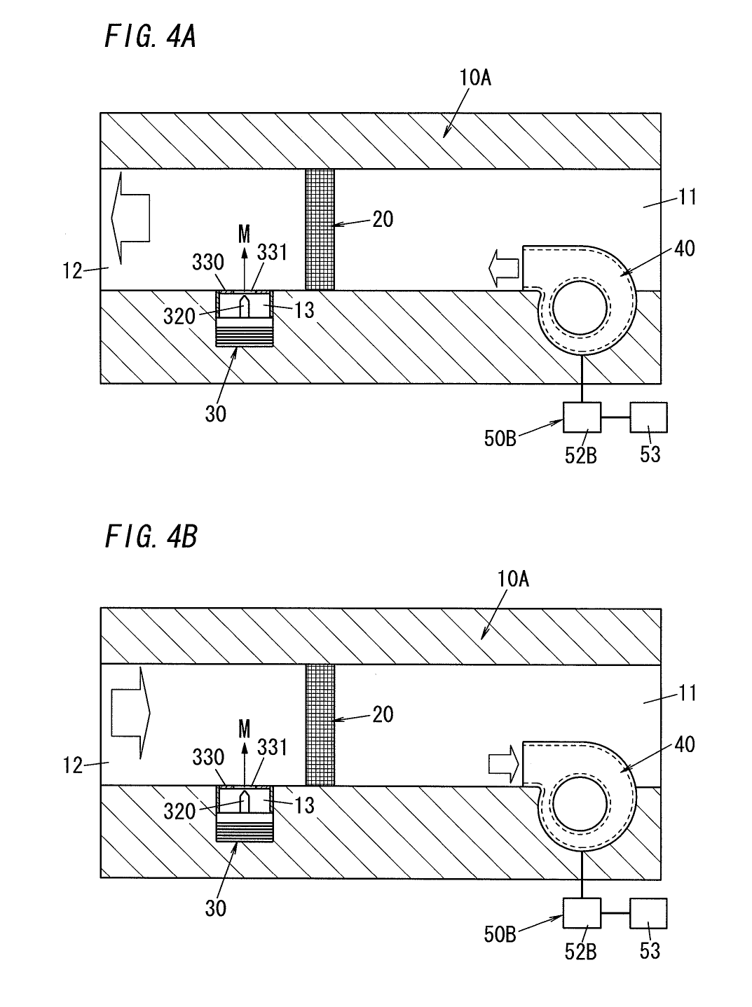

As shown in FIG. 4, the air purification apparatus of the present embodiment is mainly different from that of the first embodiment in the switching device 50B. Besides, with regard to components common to the present embodiment and the first embodiment, no detailed explanations are deemed necessary.

In the air purification apparatus of the present embodiment, like the instance shown in FIG. 3, the electrostatically atomizing device 30 is accommodated within the storage recess 13 of the duct 10A.

The electrostatically atomizing device 30 is accommodated within the storing recess with its spray hole 331 directed towards the opening of the storing recess 13. Therefore, the electrostatically atomizing device 30 discharges a mist of charged minute water particles to the space formed inside of the duct 10 between the filter 20 and the outlet 12.

The switching device 50B includes the control unit 52B and the manipulation unit 53.

The control unit 52B is configured to control the fan 40 and the control circuit 390 in conformity with the operation mode of the air purification apparatus. The control unit 52B selects one of the first mode and the second mode in response to manual operation of the manipulation unit 53. Besides, the control unit 52B controls the fan 40 and the control circuit 390 in a similar manner as seen in the control unit 52 of the first embodiment, and no explanation thereof is deemed necessary.

When the first mode is selected, the control unit 52B controls the fan 40 to operate in the air supply mode (see FIG. 4A). Therefore, in the first mode, the fan 40 sends air towards the downstream side. Thus, a mist of charged minute water particles discharged between the outlet 12 and the filter 20 is moved towards the outlet 12 as being carried on an air flow. Accordingly, in the first mode, a mist of charged minute water particles is discharged out from the outlet 12 without contacting with the filter 20.

When the second mode is selected, the control unit 52B controls the fan 40 to operate in the exhaust mode (see FIG. 4B). Therefore, in the second mode, the fan 40 sends air towards the upstream side. Thus, a mist of charged minute water particles discharged between the outlet 12 and the filter 20 is moved towards the filter 20 as being carried on an air flow. Accordingly, in the second mode, a mist of charged minute water particles contacts with the filter 20.

As seen from the above, the switching device 50B of the present embodiment includes the control circuit 52B defined as a control means configured to control the fan 40. The control circuit 52B controls the fan 40 to operate in the air supply mode when the first mode is selected, and controls the fan 40 to operate in the exhaust mode when the second mode is selected.

As described in the above, in the air purification apparatus of the present embodiment, the electrostatically atomizing device 30 is configured to discharge a mist of charged minute water particles into the space formed inside of the duct 10 between the filter 20 and the outlet 12. The fan 40 is configured to operate in the air supply mode of sending air from the inlet 11 to the outlet 12, and the exhaust mode of sending air from the outlet 12 to the inlet 11. The switching device 50B includes the control circuit 52B configured to control the fan 40. The control circuit 52B is configured to control the fan 40 to operate in the air supply mode when the first mode is selected, and to control the fan 40 to operate in the exhaust mode when the second mode is selected.

Consequently, the air purification apparatus of the present embodiment also produces the same effect as the air purification apparatus of the first embodiment. Especially, in the present embodiment, the first mode and the second mode are switched by only switching the working mode between the air supply mode and the exhaust mode. Therefore, it is possible to easily and successfully select one of the first mode and the second mode. In addition, it is possible to reduce the production cost, because of that the electric motor 51 is unnecessary.

### Third Embodiment

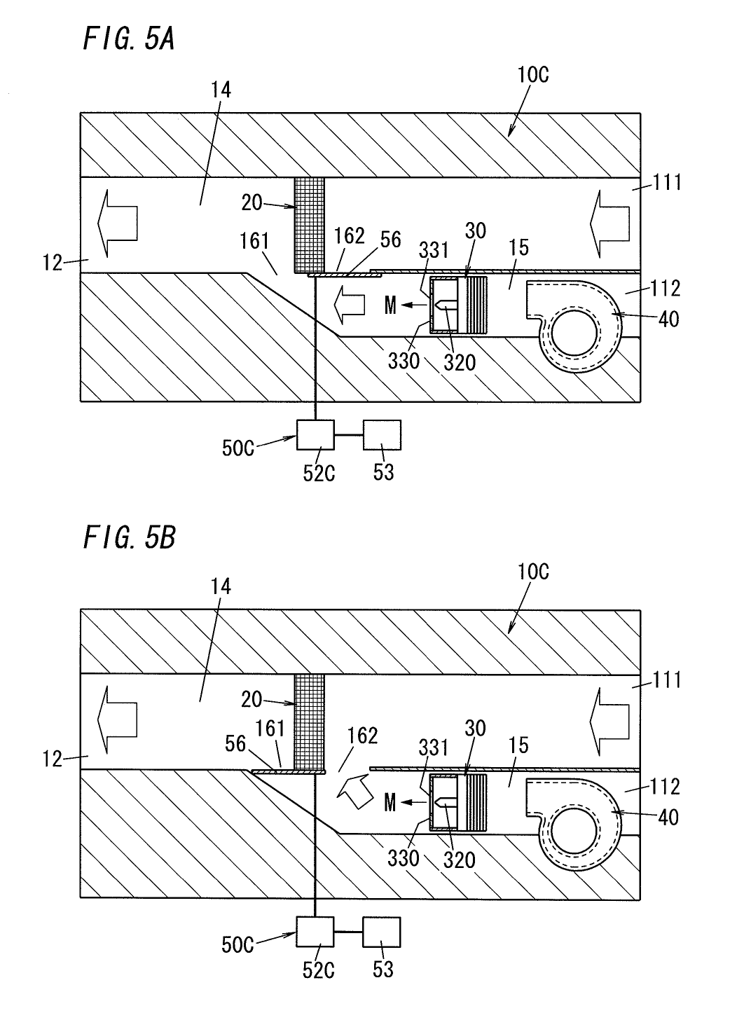

As shown in FIG. 5, the air purification apparatus of the present embodiment is mainly different from the first embodiment in the configurations of the duct 10C and the switching device 50C. Besides, with regard to components common to the present embodiment and the first embodiment, no detailed explanations are deemed necessary.

The duct 10C is provided with a first inlet 111 and a second inlet 112. The duct 10C has a main channel 14 connecting the first inlet 111 to the outlet 12. The duct 10C has an auxiliary channel 15 connecting the second inlet 112 to the outlet 12. The duct 10C includes a first confluent opening 161 and a second confluent opening 162 respectively connecting the main channel 14 to the auxiliary channel 15.

The first confluent opening 161 connects the auxiliary channel 15 to the main channel 14 between the outlet 12 and the filter 20 (that is, downstream side). The second confluent opening 162 connects the auxiliary channel 15 to the main channel 14 between the first inlet 111 and the filter 20 (that is, upstream side).

In the present embodiment, the electrostatically atomizing device 30 is located inside of the auxiliary channel 15 while the spray hole 331 is directed toward the outlet 12. In the present embodiment, the electrostatically atomizing device 30 is located in a center part of the auxiliary channel 15 not to occlude the auxiliary channel 15.

In addition, the fan 40 is installed in the duct 10C to send air from the second inlet 112 (upstream side) to the electrostatically atomizing device 30 (downstream side).

As seen from the above, in the air purification apparatus of the present embodiment, the duct 10C has two air passages (that is, a first air passage and a second air passage) between the outlet 12 and the electrostatically atomizing device 30.

The first air passage is defined by the auxiliary channel 15, the first confluent opening 161, and the main channel 14. The first air passage is devoid of the filter 20 between the outlet 12 and the electrostatically atomizing device 30 (see FIG. 5A).

The second air passage is defined by the auxiliary channel 15, the second confluent opening 162, and the main channel 14. The second air passage is provided with the filter 20 between the outlet 12 and the electrostatically atomizing device 30 (see FIG. 5B).

The switching device 10C includes a shutter 56, the control unit 52C, and the manipulation unit 53.

The shutter 56 is configured to move (slide) between a first position in which the shutter 56 close only the first confluent opening 161 and a second position in which the shutter 56 close only the second confluent opening 162. In other words, the shutter 56 is defined as a switching valve configured to close the first air passage and the second air passage selectively. As apparent from the above, the air purification apparatus of the present embodiment is provided with a confluence selecting structure for selecting a confluence of the main channel 14 with the auxiliary channel 15 from which one of the points downstream and upstream of the filter 20.

The control unit 52C is configured to control the shutter 56 and the control circuit 390 in accordance with the operation mode of the air purification apparatus. The control unit 52C selects one of the first mode and the second mode in response to manual operation of the manipulation unit 53. Besides, the control unit 52C controls the control circuit 390 in the same manner as the control unit 52 of the first embodiment, and therefore no explanation thereof is deemed necessary. The fan 40 operates in the air supply mode irrespective of selection of the first mode and the second mode.

The control unit 52C places the shutter 56 in the second position when the first mode is selected (see FIG. 5A). Therefore, in the first mode, the second air passage is kept closed, and the first air passage is kept opened. Thus, a mist of charged minute water particles discharged from the electrostatically atomizing device 30 passes the first air passage. As a result, in the first mode, a mist of charged minute water particles is discharged into the external space via the outlet 12 not through the filter 20.

The control unit 52C places the shutter 56 in the first position when the second mode is selected (see FIG. 5B). Therefore, in the second mode, the first air passage is kept closed, and the second air passage is kept opened. Thus, a mist of charged minute water particles discharged from the electrostatically atomizing device 30 passes the second air passage. As a result, in the second mode, a mist of charged minute water particles is allowed to contact with the filter 20.

Besides, irrespective of selection of the first mode and the second mode, air coming into the duct 10C via the first inlet 111 is discharged out from the outlet 12 through the filter 20.

As described in the above, in the air purification apparatus of the present embodiment, the duct 10C includes the first air passage and the second air passage. The first air passage is not provided with the filter 20 between the outlet 12 and the electrostatically atomizing device 30, and the second air passage is provided with the filter 20 between the outlet 12 and the electrostatically atomizing device 30. The switching device 50C includes the shutter 56 configured to shut the first air passage and the second air passage selectively, and the control unit 52C configured to control the shutter 56. The control unit 52C is configured to control the shutter 56 to block the second air passage when the first mode is selected, and to control the shutter 56 to block the first air passage when the second mode is selected.

Accordingly, the air purification apparatus of the present embodiment also gives the same effect as the air purification apparatus of the first embodiment. Especially, in the present embodiment, the shutter 56 is moved to switch one of the first mode and the second mode. Therefore, it is possible to easily and successfully select one of the first mode and the second mode.

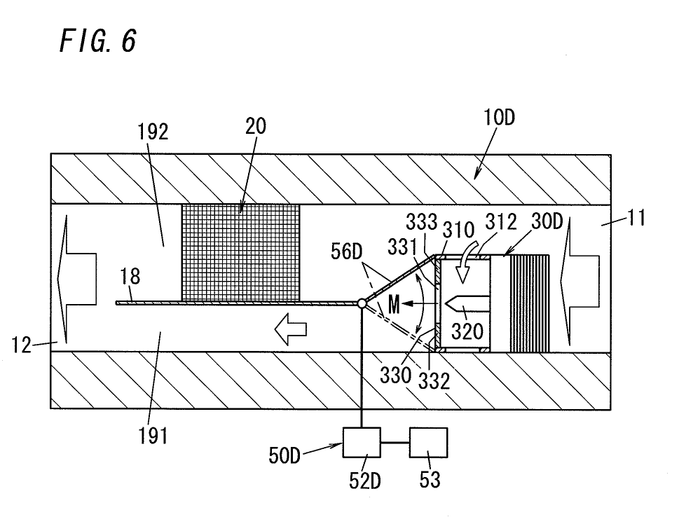

FIG. 6 shows a modification of the air purification apparatus of the present embodiment.

In the instance shown in FIG. 6, the duct 10D includes the inlet 11 and the outlet 12.

The electrostatically atomizing apparatus 30D is located close to the inlet 11 within the duct 10D. The electrostatically atomizing device 30 has its spray hole 331 directed toward the outlet 12. The electrostatically atomizing device 30 shown in FIG. 6 is provided with an air hole 312 in its side wall. Partial air coming into the duct 10D via the inlet 11 comes into the housing 310 through the air hole 312.

The duct 10D shown in FIG. 6 is provided with a partition wall 18 between the outlet 12 and the electrostatically atomizing device 30. The partition wall 18 divides the inner space of the duct 10D in two portions in order to form a first channel 191 and a second channel 192. With regard to the instance shown in FIG. 6, the filter 20 is placed inside of the second channel 192.

As apparent from the above, in the air purification apparatus shown in FIG. 6, the duct 10D has two air passage (i.e., first air passage and second air passage) between the outlet 12 and the electrostatically atomizing device 30.

The first air passage is defined by the first channel 191 in association with a space between the electrostatically atomizing device 30 and the partition wall 18. The first air passage is not provided with the filter 20 between the outlet 12 and the electrostatically atomizing device 30.

The second air passage is defined by the second channel 192 in association with the space between the electrostatically atomizing device 30 and the partition wall 18. The second air passage is provided with the filter 20 between the outlet 12 and the electrostatically atomizing device 30.

The switching device 50D shown in FIG. 6 includes the shutter 56D, the control unit 52D, and the manipulation unit 53.

The shutter 56D is attached to an end of the partition wall 18 adjacent to the inlet 11 so as to move (rotate) between a first position and a second position.

The first position is defined as a position (position of the shutter 56D illustrated with broken lines in FIG. 6) in which the shutter 56D blocks a clearance between the partition wall 18 and a first end (lower end, in FIG. 6) 332 of the opposed electrode 330 in order to prevent a mist of charged minute water particles from coming into the first channel 191.

The second position is defined as a position (position of the shutter 56D illustrated with solid lines in FIG. 6) in which the shutter 56D blocks a clearance between the partition wall 18 and a second end (upper end, in FIG. 6) 333 of the opposed electrode 330 in order to prevent a mist of charged minute water particles from coming into the second channel 192.

In brief, the shutter 56D is defined as a switching valve configured to close one of the first air passage and the second air passage. As apparent from the above, the air purification apparatus of the present embodiment is provided with a confluence switching structure for selecting one of the first channel 191 and the second channel 192.

The control unit 52D is configured to control the shutter 56D and the control circuit 390 in accordance with the operation mode of the air purification apparatus. The control unit 52D selects one of the first mode and the second mode in response to manual operation of the manipulation unit 53. Besides, the control unit 52D controls the control circuit 390 in the same manner as the control unit 52 of the first embodiment, and therefore no explanation thereof is deemed necessary.

The control unit 52D places the shutter 56D in the second position when the first mode is selected. Therefore, in the first mode, the second air passage is kept closed, and the first air passage is kept opened. Thus, a mist of charged minute water particles discharged from the electrostatically atomizing device 30 passes the first air passage. As a result, in the first mode, a mist of charged minute water particles is discharged into the external space via the outlet 12 without said particles contacting with the filter 20.

The control unit 52D places the shutter 56D in the first position when the second mode is selected. Therefore, in the second mode, the first air passage is kept closed, and the second air passage is kept opened. Thus, a mist of charged minute water particles discharged from the electrostatically atomizing device 30 passes the second air passage. As a result, in the second mode, a mist of charged minute water particles is allowed to contact with the filter 20.

Besides, in both the first mode and the second mode, air coming into the duct 10D via the inlet 11 is discharged out from the outlet 12 through the filter 20.

The modification of the air purification apparatus shown in FIG. 6 also provides the same effect as the air purification apparatus shown in FIG. 5.

1. An air purification apparatus comprising:
a duct having an inlet and an outlet;
a filter designed to purify air and placed inside of said duct;
an electrostatically atomizing device configured to generate a mist of charged minute water particles by means of electrostatically atomizing phenomenon and discharge the same into said duct; and
a fan configured to send air from said inlet to said outlet,
wherein said air purification apparatus comprises a switching means configured to switch one of a first mode of purifying air and a second mode of regenerating said filter, and
said air purification apparatus being configured to discharge a mist of charged minute water particles generated by said electrostatically atomizing device into an external space via said outlet not through said filter in said first mode, and to make the mist of charged minute water particles generated by said electrostatically atomizing device into contact with said filter in said second mode.

2. An air purification apparatus as set forth in claim 1, wherein
said electrostatically atomizing device is configured to discharge a mist of charged minute water particles into a space formed inside of said duct between said filter and said outlet,
said switching means including a changing means configured to change a discharge direction where said electrostatically atomizing device discharges a mist of charged minute water particles, and a controlling means configured to control said changing means, and
said controlling means being configured to direct said discharge direction toward said outlet in said first mode, and to direct said discharge direction toward said filter in said second mode.

3. An air purification apparatus as set forth in claim 1, wherein
said electrostatically atomizing device is configured to discharge a mist of charged minute water particles into a space formed inside of said duct between said filter and said outlet,
said fan being configured to operate in an air supply mode of sending air from said inlet to said outlet, and an exhaust mode of sending air from said outlet to said inlet,
said switching, means including a controlling means configured to control said fan, and
said controlling means being configured to control said fan to operate in said air supply mode when said first mode is selected, and to control said fan to operate in said exhaust mode when said second mode is selected.

4. An air purification apparatus as set forth in claim 1, wherein
said electrostatically atomizing device is placed inside of said duct,
said duct including, between said outlet and said electrostatically atomizing device, a first air passage devoid of said filter and a second air passage provided with said filter,
said switching means including a shutter configured to block said first air passage and said second air passage selectively, and a controlling means configured to control said shutter, and
said controlling means being configured to control said shutter to block said second air passage when said first mode is selected, and to control said shutter to block said first air passage when said second mode is selected.

5. An air purification apparatus as set forth in claim 1, wherein
said electrostatically atomizing device is configured such that an amount of a mist of charged minute water particles generated per unit time is greater in said second mode than in said first mode.
